(19) United States
(12) Patent Application Publication
(10) Pub. No.: US 2014/0195893 A1
(43) Pub. Date: Jul. 10, 2014

(54) Method and Apparatus for Generating Webpage Content

(71) Applicant: Alibaba Group Holding Limited, Grand Cayman (KY)

(72) Inventor: Ping Lei, Beijing (CN)

(73) Assignee: Alibaba Group Holding Limited, Grand Cayman (KY)

(21) Appl. No.: 14/148,562

(22) Filed: Jan. 6, 2014

(30) Foreign Application Priority Data
Jan. 7, 2013 (CN) 201310005210.5

(51) Int. Cl. G06F 17/22

(52) U.S. Cl. CPC G06F 17/2247
USPC 715/234

(57) ABSTRACT

The present disclosure provides a method and an apparatus for automatic webpage content generation. A product information server system stores in a product information database a plurality of parameter values of various product information contents and corresponding product information details related to the various product information contents. The server system places a current product information content on a webpage, receives from a web server a parameter value of the current product information content visited on the webpage, finds a product information detail corresponding to the current product information content, and returns the found product information detail to the web server. In response, the web server automatically organizes a content of a landing page using the received product information detail. The method enables automatic and dynamic web content organization and presentation to more efficiently provide relevant product information to users.

### RELATED PATENT APPLICATIONS

This application claims foreign priority to Chinese Patent Application No. 201310005210.5 filed on Jan. 7, 2013, entitled “METHOD AND APPARATUS FOR GENERATING WEBPAGE CONTENT”, Chinese Patent Application is hereby incorporated by reference in its entirety.

### TECHNICAL FIELD

The present application relates to webpage processing, and more particularly to generating a content page.

### BACKGROUND

Internet media deliver product information on a website by providing product information, such as an image of a product and a corresponding web link address, on a webpage. When visitors click on the image on the webpage, the browser jumps to a landing page corresponding to the link.

Some sites set the address of the landing page to be a web address of a preset webpage. As shown in FIG. 7, arrow 701 points to an area which displays an image of a designer handbag, which image links to a landing page that contains information of a variety of handbags. As a user clicks on the image of the designer handbag, the browser jumps to the landing page shown in FIG. 8, which displays information of handbags of different brands.

A problem of the current technology as described above is that, as the visitor clicks on the product information of each product, the browser jumps to a fixed landing page which contains product information of multiple products which do not necessarily match the product the visitor has clicked on. Because each product may require its own landing page, it is labor intensive and costly to set up the contents of different landing pages for various products whose information is displayed to be clicked by users. At the same time, the product information displayed on the fixed landing page may be unrelated to the product click by the user. As a result, the user may need to perform further search to find a desired product. This entails sending more search requests to the server, resulting in more user time spent on searching and increased burden on the server.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure provides a method and an apparatus for automatically generating a page content. According to one embodiment of the method, a computer or a computer system receives through a browser an access request by a user for accessing a current product information content on an access page; determines a parameter value of the current product information content by parsing the access request; searches in a product information database to find a detail of the current product information content by matching the parameter value; automatically organizes a content of a landing page using the find product information detail; and returns the content of the landing page to the browser.

The access request may include a link address of the current product information content requested to be accessed, where the link address may include the parameter value corresponding to the current product information content. Parsing the access request to determine the parameter value of the current product information content may comprise resolving the link address to extract the parameter value.

The product information database typically includes a plurality of parameter values of various product information contents and a plurality of product information details associated with the various product information contents, where the plurality of parameter values includes the parameter value of the current product information content requested to be accessed. In one embodiment, the parameter value includes a product number corresponding to the current product information content.

In one embodiment, to automatically organize the content of the landing page, the computer extracts from a link address of the current product information content an HTML text. The computer then adds the product information detail associated with the current product information content to the HTML text, and includes the resultant HTML text in the landing page.

The parameter value may also include at least one of a search keyword, a price data, a product category data, and a promotion data. The search keyword can be extracted from the user's behavioral data of accessing the access page recorded at the browser. The product category data and the promotion data can be extracted from the product information database.

The method may also search in the product information database to find recommended product information of a recommended product, and include at least some of the recommended product information into the content of the landing page. The recommended product information may be defined according to a preset similarity rule in relation to the parameter value. For example, the recommended product information may be retrieved from the product information database by performing a search based on the similarity rule in relation to the parameter value.

In another embodiment, to automatically organize the content of the landing page using the product information detail of the product information, the computer extracts from a link address of the current product information content an HTML text, adds the product information detail associated with the current product information content to a first location of the HTML text, and adds recommended product information to a second location of the HTML text, wherein the recommended product information is related to the current product information content according to a preset similarity rule in relation to the parameter value. The computer then includes the resultant HTML text in the landing page. The first location which contains the product information detail associated with the current product information content may be rendered at a top of the landing page.

In one embodiment, prior to determining the parameter value of the current product information content by parsing the access request, the method further determines whether the access page is another landing page of a previous access request,updates a statistics of the current product information content if the determination is affirmative, and skips the statistics if the determination is negative.

The parameter value may also include a statistics link of the current product information content, and the computer may include the statistics link into the content of the landing page along with the product information detail associated with the current product information content.

The computer may further include a process of generating a statistics link of the product information and including the statistics link in the parameter value. For example, this process may include the following steps: obtaining historical click rates of various product information contents on the access page; retrieving click prices of the various product information contents; ranking the various product information contents according to the respective historical click rates and click prices; determining if the next product information content in the ranking has a click price greater than the click price of the current product information content; and, if the determination is affirmative, generating the statistics link using the click price of the current product information content, or, if the determination is negative, generating the statistics link using the click price of the next product information content in the ranking.

According to another aspect of the method for generating page content, a product information server system performs the following:

storing a plurality of parameter values of various product information contents and corresponding product information details in a product information database; placing a current product information content on a webpage; receiving from a web server a parameter value of the current product information content visited on the webpage; finding a product information detail corresponding to the current product information content; and returning the found product information detail to the web server.

The web server then automatically organizes a content of a landing page using the received product information detail.

The present disclosure also describes a computer-based apparatus for generating page content. The apparatus includes a computer having a processor, computer-readable memory and storage medium, and I/O devices. The computer is programmed to have functional modules including:

a database module for storing in a product information database a plurality of parameter values of various product information contents and corresponding product information details, and for placing a current product information content on a webpage;

a parameter value determination module configured for receiving from a web server a parameter value of the current product information content visited on the webpage; and

a search module configured for finding a product information detail associated with the current product information content, and returning the found product information detail to the web server, to allow the web server to automatically organize a content of a landing page using the received product information detail.

Other features of the present disclosure and advantages will be set forth in the following description, and in part will become apparent from the description, or understood by practice of the application. Purposes of this application and other advantages can be obtained by the written description, claims, and drawings of the structure particularly pointed out realized and attained.

### BRIEF DESCRIPTION OF THE FIGURES

FIG. 1 is a flowchart of a first example method for generating a page content in accordance with the present disclosure.

FIG. 2 is a flowchart of a second example method for generating a page content in accordance with the present disclosure.

FIG. 3 is a flowchart of a third example method for generating a page content in accordance with the present disclosure.

FIG. 4 is a block diagram showing a first example of an apparatus for generating a page content in accordance with the present disclosure.

FIG. 5 is a block diagram showing a second example of an apparatus for generating a page content in accordance with the present disclosure.

FIG. 6 a block diagram showing a third example of an apparatus for generating a page content in accordance with the present disclosure.

FIG. 7 is a schematic view of a page displaying product information.

FIG. 8 is a schematic representation of an example landing page in the prior art.

FIG. 9 is a schematic view of another page displaying product information.

FIG. 10 is a schematic representation of an example landing page in accordance with the present disclosure.

### DETAILED DESCRIPTION

In order to facilitate understanding of the above purpose, characteristic and advantages of the present disclosure, the present disclosure is described in further detail in conjunction with accompanying figures and example embodiments. In the description, the term “technique(s),” for instance, may refer to method, apparatus device, system, and/or computer-readable instructions as permitted by the context above and throughout the present disclosure.

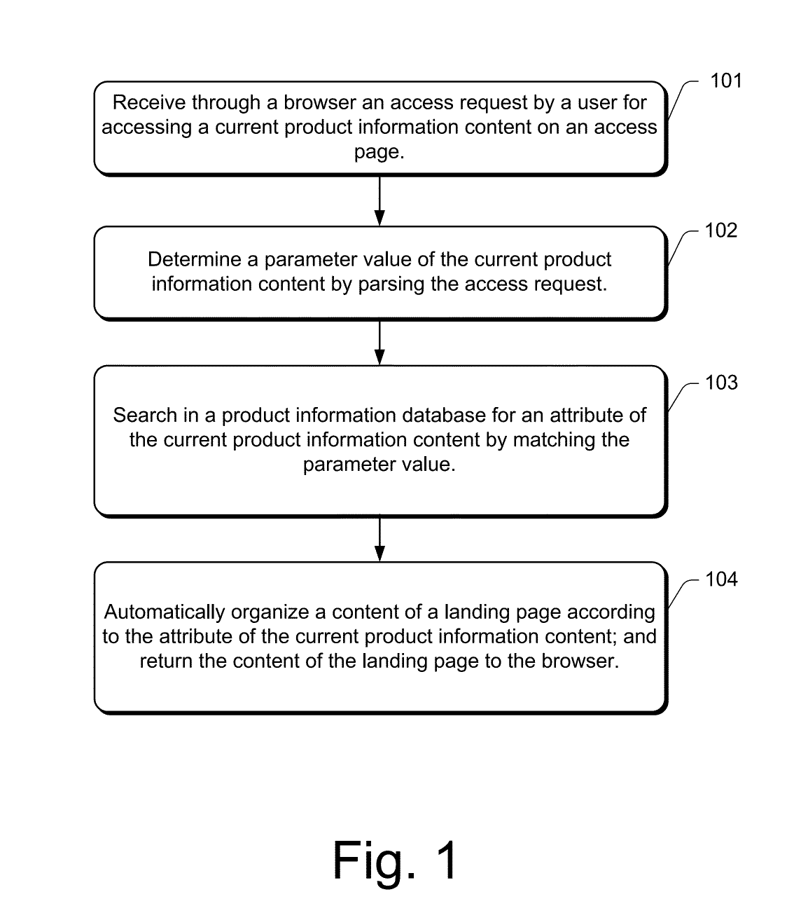

FIG. 1 is a flowchart of a first example method for generating a page content in accordance with the present disclosure. The method is described in various blocks as follows.

At block 101, a computer receives through a browser an access request by a user for accessing a current product information content on an access page.

In one embodiment, the access page is a webpage, and a product information server system places product information content on the webpage to be accessed by users. To do this, the product information content may be added to the HTML text of the webpage. In practice, the product information content is added by placing a corresponding code into the HTML text. The code may include product information to be displayed, a parameter value of the product information displayed, and a link address associated with the product information. The link address leads to a landing page, which is another webpage.

The user uses a browser to visit the access page containing the product information content. The access page may be a webpage of a collection of information of popular products, the home page of a website, a sub page, or a sidebar of a webpage). As the user visits the access page, the access page displays the product information content placed by the product information server system. The product information content displayed usually includes basic information such as a product name, a price of the product, and a picture of the product, displayed in images, texts, and videos.

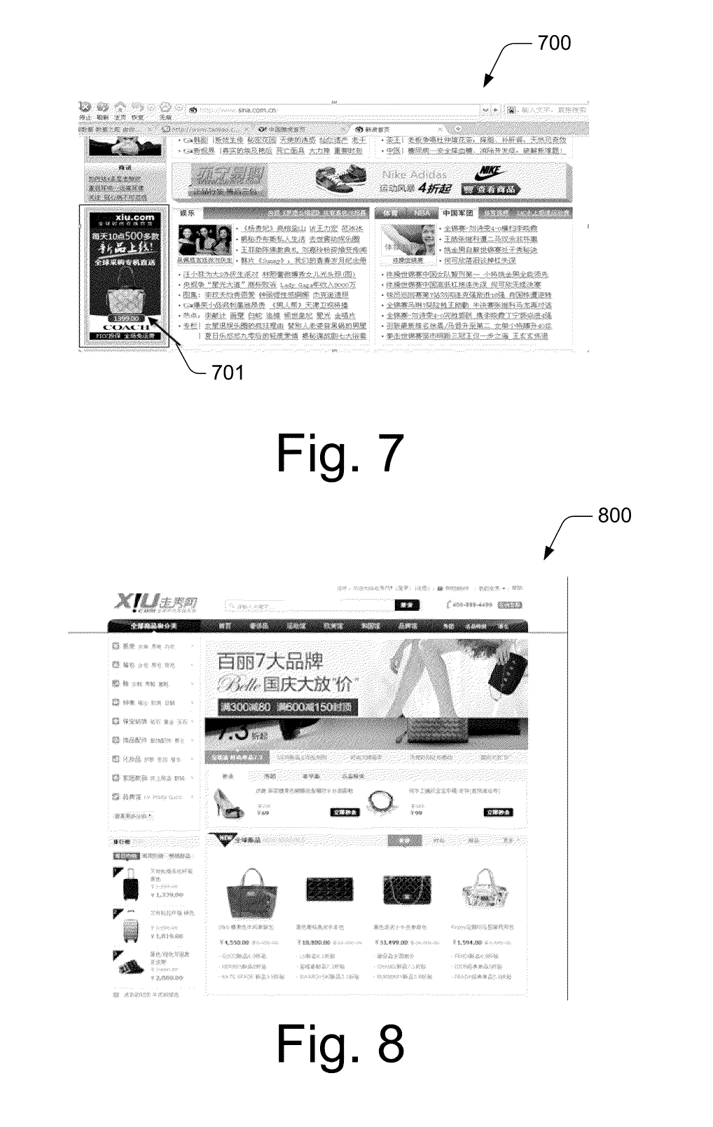

An example of displayed product information content is shown in FIG. 7 which is a schematic view of a webpage 700 displaying product information. Arrow 701 points to an area which displays product information (e.g., an image) of a designer handbag, which links to a landing page 800 (FIG. 8) that contains product information of a variety of handbags.

As the user clicks on the product information (e.g., an image) displayed in the area pointed to by arrow 701, an access request is generated and sent to a server, which, upon receiving the access request, returns more product information to the browser to be displayed in the landing page 800.

At block 102, the computer determines a parameter value of the current product information content by parsing the access request.

As the user clicks the current product information content displayed on the access page, a link address associated with the displayed product information content is triggered. For example, the browser follows a web link associated with the displayed product information and jumps to the landing page 800 shown in FIG. 8, which displays more information of handbags of different brands. Usually, the landing page 800 may provide more detailed product information which is related to the product information content displayed in the access page 700.

More specifically, the browser extracts a parameter value associated with the current displayed product information from the HTML text of the access page currently visited by the user, inserts the parameter value to the link address (e.g., a URL address) underlying the current displayed product information, and sends an access request containing the resultant link address (which now contains the parameter value extracted by the browser) to a server.

Upon receiving the access request, the server parses the access request to determine the parameter value of the current product information.

At block 103, the computer searches in a product information database to find a product information detail associated with the current product information content, by matching the parameter value.

In one embodiment, the product information server system has preconfigured a product information database which stores parameter values of various product information and corresponding product information details, which may be detailed descriptions of various products. For example, a product information detail may be a detailed product specification, or a user guide, etc. In an embodiment, a parameter value of a product information content may include a product number. The product information database stores product numbers and product information details of each product.

Take product information of a mobile phone for example, TABLE 1 lists the parameter value (which is a product number in this example) and the product information detail of a mobile phone. The product information detail may be retrieved according to the product number.

TABLE 1

| | |
|---|---|
| Product number | A110 |
| Product information detail | Specs: white, 3.5 inch touchscreen |
| | user guide: xxxxxx |

In another embodiment, the parameter value may also include a unique identifier of the product information, for example an identifier made up by the name of the product information issuer and the name of the product. The product information database stores the names of product information issuers who distribute the various product information contents, product names, and the correspondences between such information and the various product information placed on webpages (access pages). The correspondences are used to find the product information detail associated with the product information accessed by the user.

At block 104, the computer automatically organizes a content of a landing page using the product information detail associated with the current product information content; and returns the content of the landing page to the browser.

In contrast to the current techniques which require manual pre-settings of the landing pages, in the present disclosure the computer (e.g., a server or a server system) acquires the product information detail associated with the current product information content accessed by the user, automatically organizes the content of a landing page using the product information detail, and returns the new content to the browser to generate a landing page. This reduces the amount of manual work and labor expenses. Furthermore, because the landing page displays the product information detail corresponding to the product information originally accessed by the user on the access page, and user receives relevant and detailed product information returned from the server without having to perform additional searches for the same product. This reduces the amount of time a user spends to search for a product, and also reduces the traffic burden on the server.

In an embodiment of the present application, the block 104 may further include the following sub-blocks: a first sub-block retrieves the corresponding HTML text according to the link address of the product information; and a second sub-block inserts the product information detail of the product information into the HTML text, and uses the resultant HTML text in the content of the landing page.

As described above, upon receiving the access request of the product information, the server, while obtaining the product information detail by searching the product information database using the product information parameter contained in the link address, may at the same time retrieve an HTML text of a landing page and further the content of the landing page to be automatically and dynamically organized based on the obtained product information detail. In the prior art techniques, the HTML text for each link address is preset and fixed. A different advertisement requires a different preset HTML text. In contrast, according to embodiments in the present disclosure, the HTML text for each link address may initially be just a webpage template containing a framework which has areas predefined according to the initial HTML text. Upon receiving the product information detail, the server adds the product information detail information to a predefined area in the HTML text. The resultant HTML text is an expanded version which is used as the content of the landing page returned to the browser. The browser then renders the content on the landing page in a desired manner.

In one embodiment, the product information parameter may also include one or more of the following: a search keyword, a price data, a product category data, and a product promotion data. Of such, the search keyword may be the keyword entered by the user in the search box on a webpage when the user searched for the product information. For example, as the user searches for product information of a Nokia mobile phone, the user enters in the search box “Nokia smart phone”. The browser records the user's behavioral data of browsing the webpages. Such behavioral data may include the search keyword currently entered. As the user clicks on the resultant product information, the browser obtains the search keyword from the behavioral data, and inserts it to the link address of the product information.

As to the price data, the product category data and the product promotion data, the browser may obtain such information by searching the product information database based on the product number (or ID). To support this function, the product information database stores not only product information details corresponding to each product number, but also one or more of price data, product category data and product promotion data corresponding to each product information. The product information database also stores webpage placement contents of the various product information.

TABLE 2 shows the parameter values of a mobile product information and its product information details in the product information database, according to a specific example:

TABLE 2

| | | |
|---|---|---|
| Parameter values | Product number | A110 |
| | Search keyword | Smart phone |
| | Price data | 3000 |
| | Product category | Mobile Communications |
| | data | |
| | Product promotion | Free voice 300 |
| | data | |

| | |
|---|---|
| Product information | Picture of the phone |
| details | Specification: white, 3.5 inch touchscreen |
| | User Guide: xxxxxx |
| Webpage placement | xxxxxx |
| content | |

According to other embodiments of the method, the computer may further find recommended product information of one or more recommended products based on the product information currently accessed by the user. To find the recommended product information, the computer may search the product information database using any one or a combination of a search keyword, price data, product category data and promotion data.

The above TABLE 2 illustrates an example of the corresponding relations between the parameter values and the product information details in the product information database. Similar to the product number, other parameter values such as the search keyword, price data, product category data and promotion data may be inserted into the link address after the user has clicked on the advertisement containing the product information displayed. Upon receiving the access request, the server may, in addition to obtaining the product information detail, use one or more parameter values to find recommended product information that has the same or a similar parameter value, and recommend the products associated with such recommended product information along with the original product accessed by the user.

For example, product information qualifies as recommended product information if it has at least one of parameter values, such as a search keyword, a price, an industry or a promotion, that is the same as or similar to that of the current product information accessed by the user. Similarly may be measured using a predefined similarity rule.

Take the data in TABLE 2 as an example, after the user has visited the product information, the server may use the search keyword to find recommended product information. Specifically, the server may find other species of product information that share the same keyword “smart phone” and use such product information as recommended product information.

In another example, if the user clicks on product information of a paper towel which is being promoted by a “buy three and get one for free” sale, the server may find information of an office desk which is also being promoted by a “buy three and get one for free” sale, and return such additional information in order to assist buyers who are interested in similar promotions, even though the two items may not be otherwise related.

Compared to the prior art techniques in which the landing page is fixed, the method disclosed herein automatically provides recommended product information that share the same or similar parameter values with the current product information accessed by the user. The method avoids presentation of unrelated product information, improves recommendation accuracy, and improves the efficiency of network resource usage.

In practice, the recommendation accuracy may be further improved by combining two or more of keywords, price data, product category data and promotion data. For example, in the above example, the paper towel has “groceries” as its product category data, while the office desk has “office equipment” as its product category data. If both the product category data and the promotion data are combined to filter the recommended products, the office desk may not be recommended because it belongs to a different category even though it is being promoted by a similar sale. Instead, another grocery product such as a hand wash may be a better product to recommend than the office desk because it may suit the needs of the user who is looking for groceries. Such combinations may improve the accuracy, shorten the user's search time in finding the desired product, and at the same time lighten the user traffic burden on the server.

When multiple parameter values are used to filter recommended product information, similarities between candidate product information and the current product information may be quantitatively calculated with regard to each parameter, and an overall match degree between the candidate product information and the current product information may be further calculated based on the similarities. Multiple pieces of candidate product information may be ranked according to their respective overall match degree, and those that are most highly ranked maybe used as recommended product information.

For example, suppose the user visits information of a certain mobile phone, and the server uses a combination of promotion data and price data to filter recommended product information. Product information of each of the four example products in the database is compared with the mobile phone information as follows:

| | Promotion data/similarity | Price data/similarity |
|---|---|---|
| | compared with the mobile | compared with the mobile |
| Product | phone | phone |
| Mobile phone | Free shipping | 2000 |
| Electronic book | Bonus 300 voice fee/0.3 | 1500/0.8 |
| Mouse | Free shipping/1.0 | 150/0.1 |
| Handbag | 30% off/0.2 | 2000/1.0 |
| Office desk | Free shipping/1.0 | 500/0.3 |

In calculating the matching degree, a similarity between each candidate product and the reference product (mobile phone) with regard to each of the two combined parameters, namely promotion data and price data, is first calculated. As shown in the above table, the similarity of promotion data is determined to be 1.0 between the product that has free shipping and the mobile phone which also has free shipping, 0.3 between “bonus 300 voice fee” and free shipping, while 0.2 between “30% off” and free shipping. With regard to the similarity of price data, the closer the two prices are, the high the similarity is. For example, the similarity between a price of 2000 and mobile phone's price of 2000 is 1.0, that between 1500 and 2000 is 0.8, while that between 150 and 2000 is only 0.1.

Similarities with regard to different parameters may be given different weights to calculate the overall match degree, which may be defined as a weighted total of the similarities. For example, if the similarity of promotion data and the similarity of price data each has a weight of 0.5, the match degree between the electronic book and the mobile phone is calculated to be 0.3×0.5+0.8×0.5=0.55. By the same token, the match degree between the other three products and the mobile phone is respectively 0.55 (mouse), 0.6 (handbag), and 0.65 (office desk). The products are ranked according to the match degree, and the highest ranked product are selected as recommended products. For example, if the top half of the ranked products are selected, the product information details of the handbag and the office desk are selected as recommended product information.

Upon finding the recommended product information, the server may retrieve the web placement content corresponding to each piece of recommended product information, and organize the retrieved web placement content along with the product information detail associated with the current product information into the content of the landing page.

To this end, the block 104 may further include the following sub blocks.

First sub-block: retrieve the HTML text according to the link address associated with the current product information.

Second sub-block: place (e.g., add or insert) the product information detail associated with the current product information in the first preset location in the HTML text, and place the web placement information related to the recommended product information in the second preset location in the HTML text. The resultant expanded HTML text is taken as the content of the landing page.

The product information detail associated with the current product information accessed by the user, and the recommended product information may be displayed on the same page. The landing page may have a predesigned template having a framework which has different areas defined by the HTML language. For example, the first preset location may be reserved for the product information detail associated with the current product information, and the second preset location in the HTML text may be preserved for the recommended product information. After such information has been inserted into its corresponding location, the resultant HTML text is used as the content of the landing page and returned to the browser. The browser renders the page content in the landing page with a certain desired effect, and as a result the user is provided not only with the product information detail associated with the product information visited, but also product information of multiple recommended products.

In one example, the first preset location is rendered at the top of the landing page such that the user may quickly identify the product information detail after clicking on the product information on the original access page. This shortens the time the user spends to locate the most relevant product information. In comparison, the second preset location may be rendered at a less prominent location on the landing page, such as of mid-lower area or a right side area etc.

The size of the display area of the first preset location on the landing page may also be set to be greater than that of the second preset location. That is, the area displaying the product information detail associated with the product information accessed is greater than the area displaying the recommended product information.

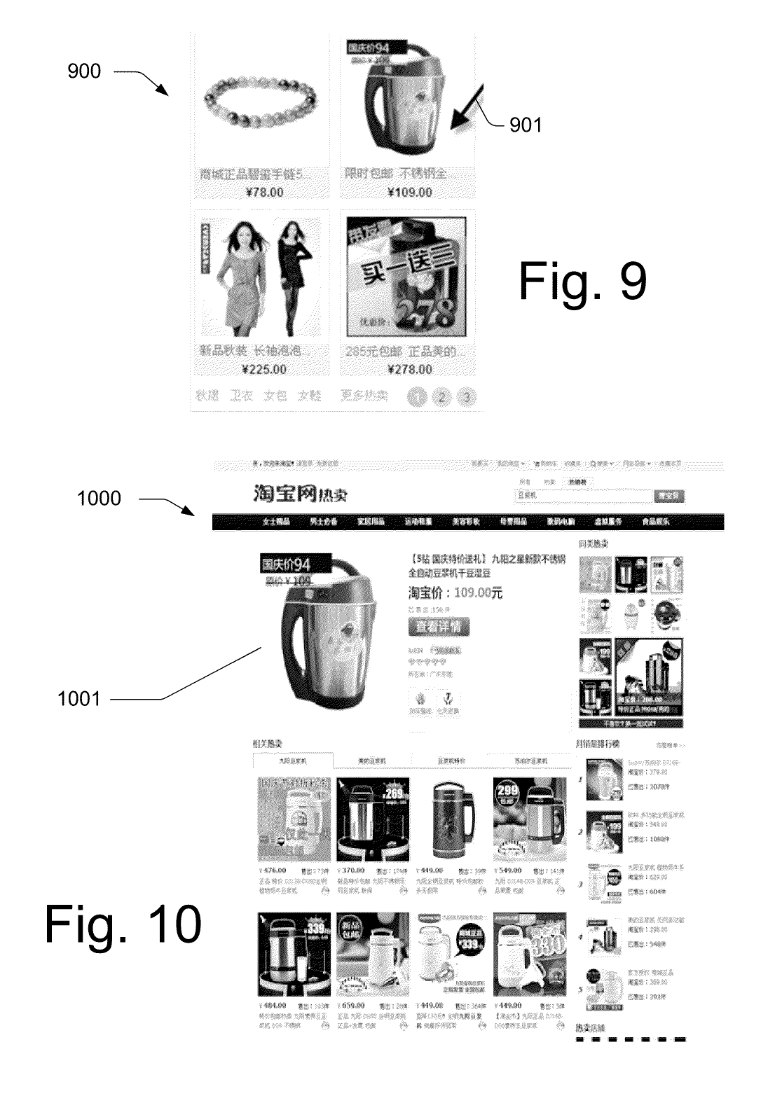

FIG. 9 is a schematic view of an example access page 900 which displays product information. Arrow 901 points to an area that displays a soybean sauce maker. As the user clicks on the displayed information (e.g., a picture) of the soybean sauce maker, the browser automatically jumps to a landing page 1000 as shown in FIG. 10, in which more detailed information of the soybean sauce maker is displayed in the most prominent area 1001, and the other recommended products are displayed in the secondary areas.

In practice, visitors often make irregular clicks on product information displayed on a webpage, and there is a need to reduce the impact of such irregular clicks, because otherwise the clicking and browsing activities resulted from such irregular may waste the server's resources in handling the traffic. To this end, a second embodiment of the method is described.

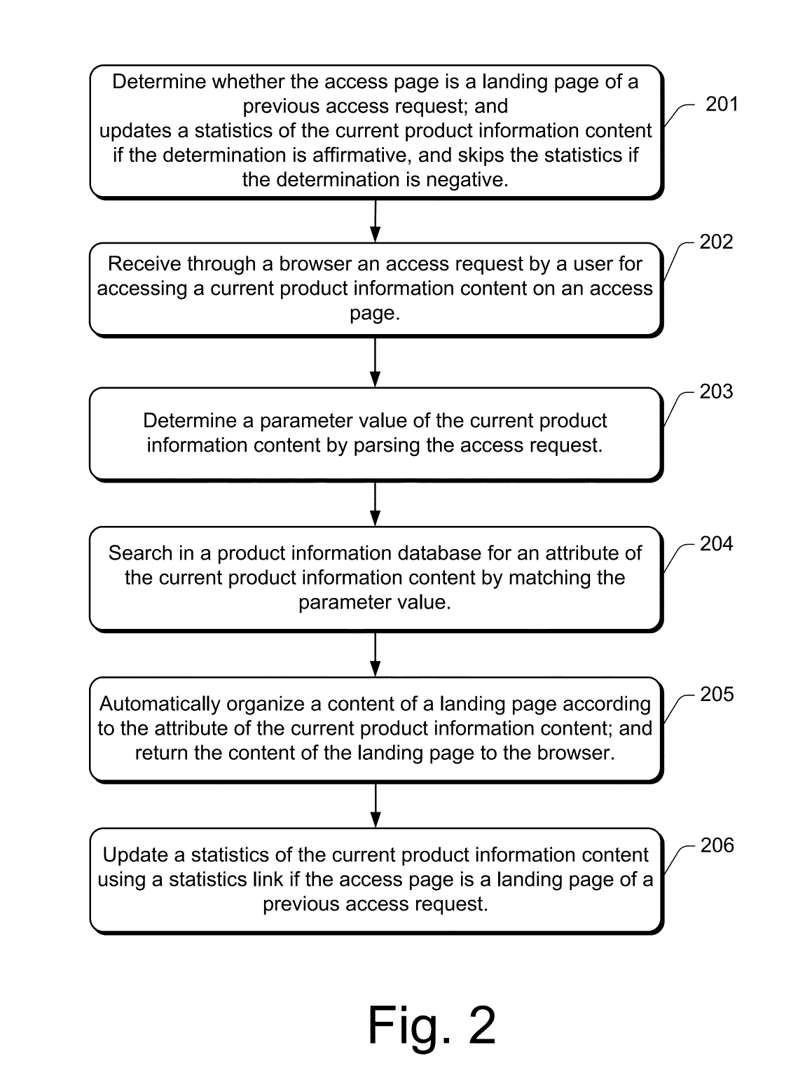

FIG. 2 is a flowchart of a second example method for generating a page content in accordance with the present disclosure. The method is described in following blocks.

At block 201, the computer determines whether the access page is a landing page of a previous access request, and updates a statistics of the current product information content if the determination is affirmative, or skips the statistics if the determination is negative.

The statistics of product information provides statistical information that can be used to accurately analyze the effective product information placement on webpages, optimize the placement effect, and control advertisement fee charges. For example, fee deductions for clicks on product information may be performed straightly according to the statistical results of the product information. The prior art Cost Per Click (CPC) methods for charging click fees is based on the number of clicks performed by users on displayed product information. The prior art fee deduction is performed right away as a user clicks the product information displayed on any access page, making the method susceptible to effect of irregular clicks such as clicks by error, malicious clicks and fraudulent clicks. Such irregular clicks result in inaccurate statistics, inaccurate fee charges, and further increases server expenses. This is not favorable condition for use experiences and webpage optimization.

According to an embodiment described herein, after the user has clicked on product information displayed on an access page, the computer first determines whether the current access page is a landing page resulted from a jump from a previous access page. If the access page is not a landing page, it suggests that this is the first time the user has clicked on the product information, and therefore no click charge is made. This practice may reduce the chargeable ineffective traffic caused by irregular clicks, and at the same time reduces server processing cost for click defense.

One way to determine whether the current access page is a landing page or not is to identify whether the web address of the current access page contains a “redirect” mark which is characteristic of a landing page after a jump. If the current access page contains such a “redirect” mark, it is a landing page.

At block 202, the computer receives through a browser an access request by a user accessing a current product information content on an access page.

At block 203, the computer determines a parameter value of the current product information content by parsing the access request.

At block 204, the computer searches in a product information database for a product information detail associated with the current product information content, by matching the parameter value.

At block 205, the computer automatically organizes a content of a landing page using the product information detail associated with the current product information content, and returns the content of the landing page to the browser.

At block 206, the computer updates a statistics of the current product information content using a statistics link if the access page is determined to be a landing page of a previous access request.

In this embodiment, no fee deduction is performed in the initial click of the product information on an original access page which is not a landing page. Instead, fee deduction is performed after the user has clicked on product information displayed on a landing page resulted from a previous click on an access page. Therefore, the statistics link of the product information may be added into the HTML of the landing page along with the associated product information detail to allow statistical processing after the user has clicked on a product information detail on the landing page.

To this end, the statistics link of the clicked product information is generated from statistics differentiating among all product information contents contained in the access page clicked by the user. The process may include the following sub-blocks.

The first sub-block: upon receiving an access request of the product information in an access page which is a landing page, the computer statistically calculates the historical click rate of each product information content on the access page, and extracts click price data of each product information content.

The second sub-block: the computer ranks the click prices and historical click rates of the product information contents on the access page.

The third sub-block: the computer determines if the next product information content in the ranking relative to the current product information content has a click price greater than the click price of the current product information content; if yes, the computer performs the following fourth sub-block, and if not, the computer performs the following fifth sub-block.

The fourth sub-block: the computer generates a statistics link using the click price of the current product information content.

The fifth sub-block: the computer generates the statistics link using the click price of the next product information content in the ranking.

In this embodiment, the product information database includes historical click rates and click prices associated with all product information contents. The click price of a product information content is the price needs to be paid by the product information issuer to the owner of the website for each legitimate click by a user at the product information content. Historical click rate is calculated by dividing the number of displays of the product information content by the number of clicks of the displayed product information content. For example, each visit of a webpage by the user results in one display of the product information on the webpage, while each click of the product information results in a visit of the product information. The data of the number of visits may be sent to the product information server system, which logs statistics of the times of displays of each product information content and the times of clicks of the respective product information content, and may use the statistics to calculate historical click rates of an advertisement (a placement of a certain product information content). If the product information content is distributed for the first time, a category average click rate is initially assigned to the product information content.

Upon obtaining the historical click rates and click prices, product information contents may be ranked accordingly. In one example, the ranking may be based on the product of multiplying the price with the click rate. Differentiating statistics may also be carried out after the user has clicked on the product information. One example of differentiating statistics is to perform bidding fee deduction. As the product information contents are ranked, the computer determines whether the click price of the next product information content in the ranked list is greater than the click price of the current product information content that is being clicked. If affirmative, the click price of the current product information content is used to generate the statistics link; if negative a bid price rather than the historic click price is charged against an advertiser's account with regard to the current product information content clicked by the user. The bid price may be the sum of the click price of the next product information content in the ranking list and a preset bid price incremental (e.g., $0.01).

For example, suppose the click price of product A is $1, and its historical click rate is 80%; the click price of product B is $2, and its historical click rate is 20%; the click price of product C is $1, and its historical click rate is 10%. If ranked by the value of multiplying the click price with the click rate, these products are ranked in order of A>B≧C.

As the visitor clicks on product A, the computer determines that product B, which is the next in line in the ranking, has a click price that is higher than that of product A, and therefore charges a fee deduction of $1 for a click on product A based on its historical click price. As the visitor clicks on product B, the computer determines that product C, which is the next in line in the ranking, has a click price that is lower than that of product B. Instead of charging the historical click price $2 of product B, a bid price of $1.01 (which is the click price $1 of product C plus the preset bid price incremental $0.01) is charged for a click on product B.

As the visitor clicks on product information contents on the landing page, fee deduction may be made differently for the primary product information and the recommended product information. For a click on product information detail associated with the product previously clicked by the user on the access page, a fee deduction may be made based on a bidding among the ranked product information contents of the original access page, while for a click on recommended product information, a fee deduction may be made based on the original fee deduction links.

In relation to the above-described embodiments, a method for generating page content by the product information service system is also described.

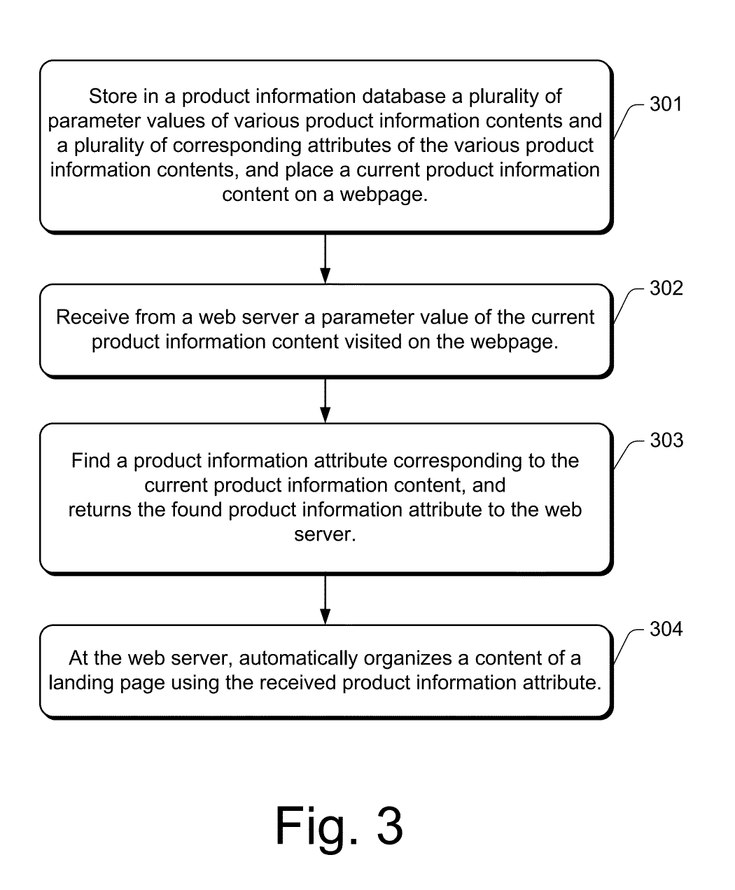

FIG. 3 is a flowchart of a third method for generating a page content in accordance with the present disclosure. The method is described in the blocks as follows.

At block 301, the product information server system stores in a product information database a plurality of parameter values of various product information contents and a plurality of corresponding product information details associated with the various product information contents. The product information service system further places a current product information content on a webpage to be accessed by users.

At block 302, the product information service system receives from a web server a parameter value of the current product information content visited on the webpage.

At block 303, the product information service system finds a product information detail corresponding to the current product information content, and returns the found product information detail to the web server.

At block 304, the web server automatically organizes a content of a landing page using the received product information detail.

As the user clicks a product information content on the webpage through a browser, the browser sends to a server a link address augmented with a parameter value of the product information content. The server parses the link address to obtain the parameter value and sends the parameter value to the product information server system, which, upon receiving the parameter value, searches the product information database to find a product information detail corresponding to the product information content clicked by the user, and returns the product information detail to the server. The server inserts the received product information detail into the HTML text which corresponds to the link address, and returns the resultant HTML text to the browser as the content of the landing page. The browser renders the HTML text returned from the server to generate the landing page.

In summary, according to the present disclosure, as a user clicks on a product information content in a webpage, a server uses a parameter value of the clicked product information content to find, in a product information database, a product information detail associated with the clicked product information content, and organizes a content of a landing page based on the found product information detail. Specifically, the server inserts the product information detail into the HTML text of the landing page. Compared to the prior art techniques, the disclosed method does not require different page contents to be manually set for different product information placed on webpages, does not need to maintain a fixed landing page for each advertisement, and therefore uses less labor and has lower expenses. At the same time, due to the placement of relevant product information detail associated with the product information content clicked by the user, both the user search time and server stress are reduced.

The product information detail associated with the product information content clicked by the user may be rendered at a prominent place on the landing page such that as the user clicks on the product information content, the subsequent landing page quickly leads the user to the relevant product information detail, further reducing the search time for the user to find the right product information.

A parameter value may include at least one of a search keyword, a price, a product category data and a product promotion data, and may be used to search for recommended product information of products that, although not the same, may be related to the original product clicked by the user. The recommended product information may also be added to the content of the landing page, such that the user may receive more relevant product information. Compared to the fixed landing page content in the prior art, this embodiment of the disclosed method avoids displaying of irrelevant product information and increases the accuracy of product recommendations. The parameter value used for searching recommended product information may combine two or more search key words, prices, product category data and product promotion data in order to further improve the accuracy.

When generating the landing page, the computer may also insert a statistics link of the visited product information into the HTML text, such that when the user clicks the product information detail of the clicked product or a recommended product information content, the click price data and the historical click rate of each product information content may be collected, and differential statistics with regard to different product information contents may be generated.

Further, the computer may decide whether the current visit by the user should be logged into the statistics, depending on whether the webpage being visited is itself a landing page of a previous access page. The visit is taken into account of the statistics of the product information visited if the webpage being visited is a landing page, and ignored if not. Compared to the prior art technique which takes every visit into statistics, the disclosed method is useful in avoiding the statistics from being affected by the invalid traffic of unintended clicks, malicious clicks and fraudulent clicks, and is also helpful in reducing the processing costs of a click defense system and increasing the efficiency of network resources.

In this description, the order in which a process is described is not intended to be construed as a limitation, and any number of the described process blocks may be combined in any order to implement the method, or an alternate method. An embodiment is described in sequential steps only for the convenience of illustration. Further, not every step or module described in the embodiments is required.

The above-described techniques may be implemented with the help of one or more non-transitory computer-readable media containing computer-executable instructions. The non-transitory computer-executable instructions enable a computer processor to perform actions in accordance with the techniques described herein. It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

In connection to the method disclosed herein, the present disclosure also provides a computer-based apparatus for processing online transactions.

In the presence disclosure, a “module” in general refers to a functionality designed to perform a particular task or function. A module can be a piece of hardware, software, a plan or scheme, or a combination thereof, for effectuating a purpose associated with the particular task or function. In addition, delineation of separate modules does not necessarily suggest that physically separate devices are used. Instead, the delineation may be only functional, and the functions of several modules may be performed by a single combined device or component. When used in a computer-based system, regular computer components such as a processor, a storage and memory may be programmed to function as one or more modules to perform the various respective functions.

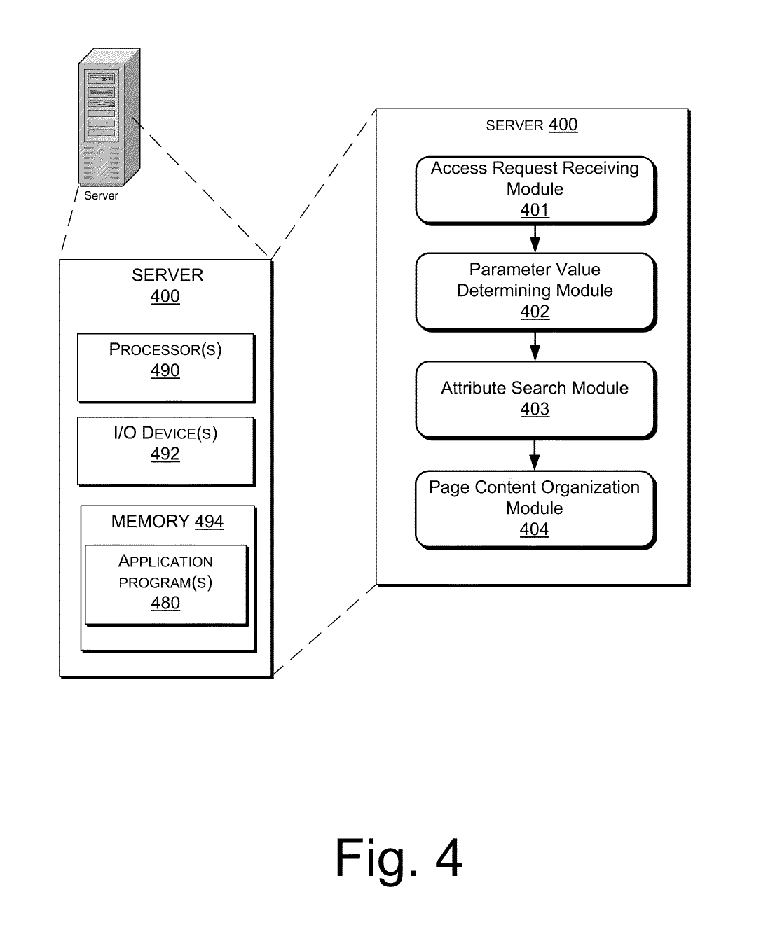

In relation to the above first method embodiment of FIG. 1, an apparatus for page content generation is described. FIG. 4 is a schematic block diagram of an apparatus based on the first example method shown herein. Server 400 has one or more processor(s) 490, I/O devices 492, memory 494 which stores application program(s) 480. The server 400 is programmed to have the functional modules as described in the following.

Access request receiving module 401 is configured for receiving an access request for product information in a webpage.

Parameter value determining module 402 is configured for parsing the received access request and determining a parameter value of the product information based on the parsing result.

Attribute search module 403 is configured for searching the preset product information database to find, by matching the search parameter, product information detail associated with the product information clicked by the user.

Page content organization module 404 is configured for organizing the content of a landing page based on the found product information detail, and returning the content to the browser.

In one embodiment, the access request received at access request receiving module 401 contains a link address which contains the parameter value. Parameter value determining module 402 may include a parsing submodule configured for parsing the received link address and extracting the parameter value contained therein.

The product information database stores parameter values of various product information contents and the corresponding product information details. A parameter value may include a product number corresponding to the visited product information.

Page content organization module 404 may include a text retrieving submodule, configured for retrieving a HTML text based on the link address of the product information, and a content adding submodule, configured for adding the found product information detail to the retrieved HTML text. The resultant HTML text is taken as the content of the landing page.

A parameter value may include any one or more of a search keyword, a price data, a product category data and a product promotion data. Of such, the search keyword may be extracted from the behavioral data of the user visiting the webpage, recorded at the browser. The price data, the product category data and the product promotion data may be found by searching the product information database according to the product number.

The product information database also stores the webpage placement contents corresponding to various product information. The server 400 is programmed to further have a recommended product information search module, configured to search the product information database to find recommended product information related to the product information visited by the user. The search is performed based on the parameter value containing at least one of a search keyword, a price data, a product category data, and a product promotion data. The web placement contents of recommended product information and the product information detail of the visited product information are both organized in the content of the landing page.

In an embodiment, page content organization module 404 includes a text retrieving submodule, configured for retrieving a HTML text based on the link address of the product information, and a content adding submodule, configured for adding the found product information detail and the found recommended product information to a first preset location and a second preset location, respectively, in the retrieved HTML text. The resultant HTML text is taken as the content of the landing page. The landing page may render the product information detail associated with the clicked product information at a prominent top position of the page.

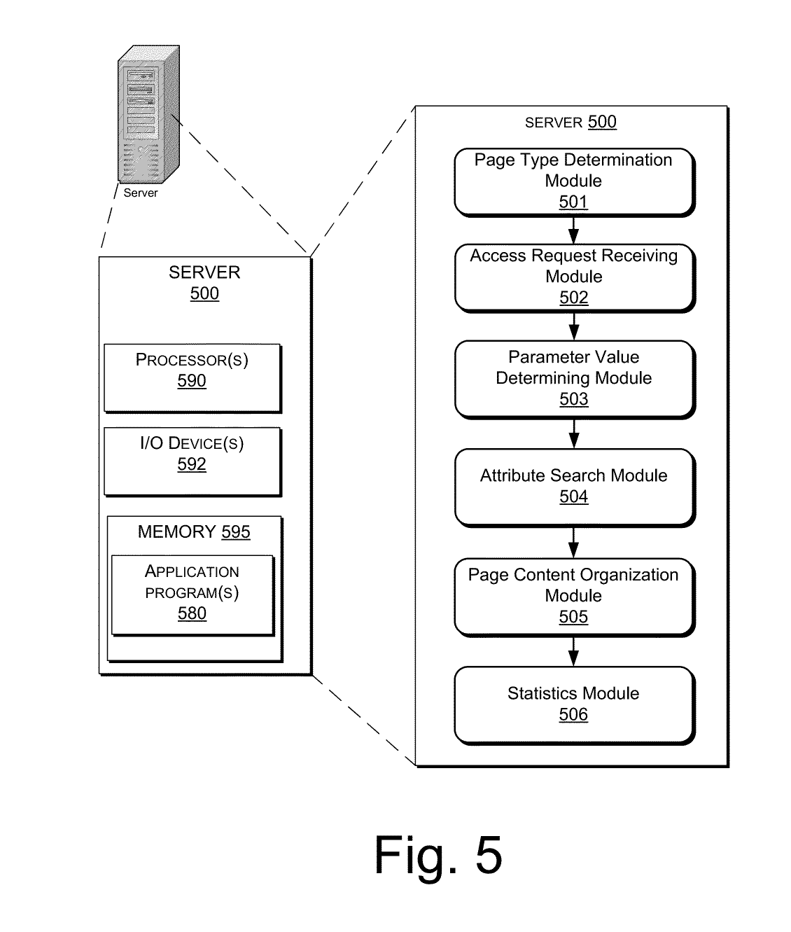

In relation to the above second method embodiment of FIG. 2, an apparatus for generating webpage content is further described. FIG. 5 is a schematic block diagram of an apparatus based on the second example method shown herein. Server 500 has one or more processor(s) 590, I/O devices 592, memory 595 which stores application program(s) 580. The server 500 is programmed to have the functional modules described in the following.

Page type determination module 501 is configured for determining whether the current webpage containing the product information visited by the user is itself a landing page as a result of the user's visiting a previous access page. If yes, statistics is logged for the visited product information; and if not, statistics is skipped. That is, as a user visits a certain product information content, whether the use activity is logged into the account of statistics depends on whether the page being visited is in its nature a landing page or not. In practice, whether statistics is logged may also determine whether of a fee deduction is performed against an advertiser's account. For example, if the webpage is a landing page, a fee deduction is performed, and if not a fee deduction is not performed.

Page type determination module 501 may include a page marker determination submodule which detects whether the web link address of the current webpage includes a “redirect” marker characteristic of a landing page.

The parameter value of the product information may also include a statistics link of the product information. Upon receiving an access request resulted from a visit to the landing page generated from a previous webpage (access page), statistics may be performed according to the statistics link. The statistics link may be placed into the content of the landing page, along with the product information detail associated with the product information initially visited by the user.

The statistics link may also serve as or include a fee deduction link to initiate or control the fee deduction operations. In one embodiment, the fee deduction link is generated using the following functional submodules:

a data acquisition submodule, for acquiring, upon receiving an access request of product information on the landing page, historical click rates and click prices of various product information contents on the landing page;

a ranking submodule, for ranking the various product information contents on the landing page according to their respective click prices and historical click rates;

a determining submodule, for determining, according to the ranking, whether the click price of the next product information content in the ranking is greater than that of the currently visited product information content; and

a fee deduction link generating module, for generating a fee deduction link based on an outcome of the determining submodule.

Specifically, if the outcome of the determined module is affirmative, the fee deduction link generating module generates a fee deduction link using the click price of the current product information content visited by the user; if the outcome is negative, the fee deduction link generating module generates a fee deduction link using the click price of the next product information content in the ranking.

Access request receiving module 502 is configured to receive an access request of the product information in the webpage.

Parameter value determining module 503 is configured to parse the received access request in order to determine a parameter value of the product information.

Product information detail search module 504 is configured to search the product information database to find product information detail associated with the product information visited by the user, by matching the parameter value.

Page content organization module 505 is configured to organize the content of landing page using the product information detail, and return the content to the browser.

Statistics module 506 is configured to perform statistic functions according to the statistics link corresponding to the product information upon receiving an access request for visiting the product information detail in the landing page.

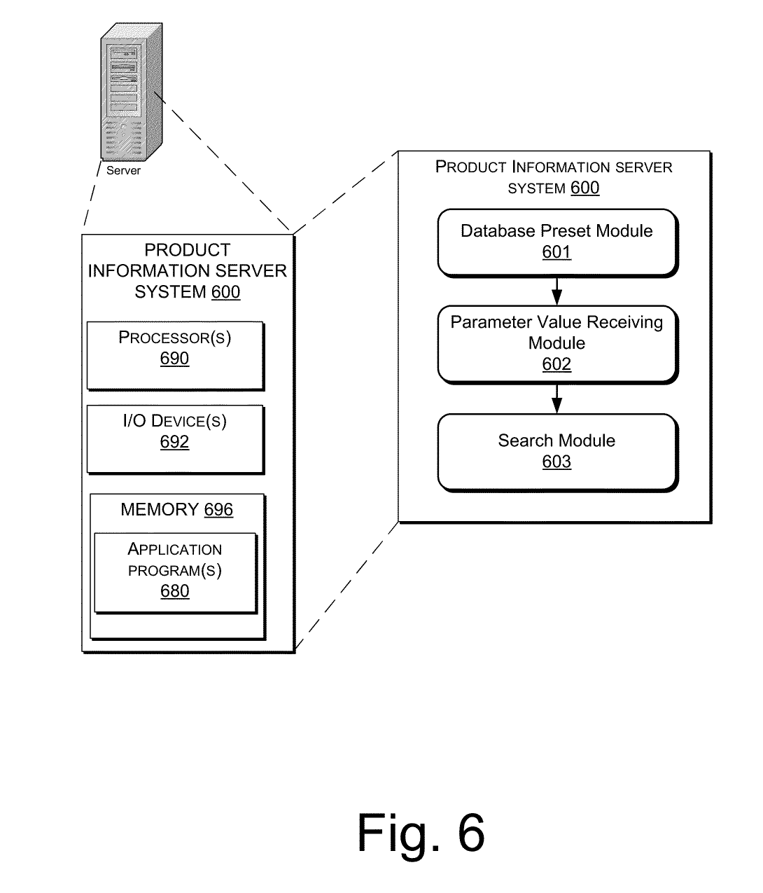

In relation to the above third method embodiment of FIG. 3, an apparatus for generating webpage content is further described. FIG. 6 is a schematic block diagram of an apparatus based on the method embodiments shown herein. Product information service system 600 has one or more processor(s) 690, I/O devices 692, memory 696 which stores application program(s) 680. The product information service system 600 is programmed to have the functional modules described as follows.

Database module 601 is configured to store in a product information database a plurality of product information details corresponding to various product information contents, and to place the product information contents on websites.

Parameter value receiving module 602 is configured to receive from a server a parameter value of a visited product information content of an accessed webpage.

Search module 603 is configured to search the product information database according to the received parameter value to find a product information detail corresponding to the visited product information content, and return the found product information detail to the server to let the server organize the content of a landing page based on the received product information detail.

The above embodiments of the apparatus for generating page content are related to the embodiments of the method described herein, and detailed description of the embodiments of the method is also applicable to the embodiments of the apparatus and is therefore not repeated.

The technique described in the present disclosure may be implemented in a general computing equipment or environment or a specialized computing equipment or environment, including but not limited to personal computers, server computers, hand-held devices or portable devices, tablet devices, multiprocessor systems, microprocessor-based systems, set-top boxes, programmable consumer devices, network PCs, microcomputers and large-scale mainframe computers, or any distributed environment including one or more of the above examples.

The modules in particular may be implemented using computer program modules based on machine executable commands and codes. Generally, a computer program module may perform particular tasks or implement particular abstract data types of routines, programs, objects, components, data structures, and so on. Techniques described in the present disclosure can also be practiced in distributed computing environments, such a distributed computing environment, to perform the tasks by remote processing devices connected through a communication network. In a distributed computing environment, program modules may be located in either local or remote computer storage media including memory devices.

It is appreciated that the potential benefits and advantages discussed herein are not to be construed as a limitation or restriction to the scope of the appended claims.

Methods and apparatus of information verification have been described in the present disclosure in detail above. Exemplary embodiments are employed to illustrate the concept and implementation of the present invention in this disclosure. The exemplary embodiments are only used for better understanding of the method and the core concepts of the present disclosure. Based on the concepts in this disclosure, one of ordinary skills in the art may modify the exemplary embodiments and application fields.

What is claimed is:

1. A method for generating a content page, the method comprising:
receiving through a browser an access request by a user for accessing a current product information content on an access page;
determining a parameter value of the current product information content by parsing the access request;
searching in a product information database for a product information detail associated with the current product information content, by matching the parameter value;
automatically organizing a content of a landing page using the product information detail associated with the current product information content; and
returning the content of the landing page to the browser.

2. The method as claimed in claim 1, wherein the access request includes a link address of the current product information content, the link address including the parameter value of the current product information content, and wherein parsing the access request to determine the parameter value of the current product information content comprises:
resolving the link address to extract the parameter value.

3. The method as claimed in claim 1, wherein the product information database stores a plurality of parameter values of various product information contents and a plurality of product information details associated with the various product information contents, the plurality of parameter values including the parameter value of the current product information content.

4. The method as claimed in claim 1, wherein the parameter value includes a product number corresponding to the current product information content.

5. The method as claimed in claim 1, wherein automatically organizing the content of the landing page comprises:
extracting from a link address of the current product information content an HTML text;
adding the product information detail associated with the current product information content to the HTML text; and
including the resultant HTML text in the landing page.

6. The method as claimed in claim 1, wherein the parameter value includes at least one of a search keyword, a price data, a product category data, and a product promotion data.

7. The method as claimed in claim 6, wherein the search keyword is extracted from the user's behavioral data of accessing the access page recorded at the browser.

8. The method as claimed in claim 6, wherein the price data, the product category data or the product promotion data in the parameter value is extracted from the product information database.

9. The method as claimed in claim 6, wherein the search keyword is extracted from the user's behavioral data of accessing the access page recorded at the browser, and the price data, the product category data or the product promotion data is extracted from the product information database, the method further comprising:
searching in the product information database for recommended product information of a recommended product, the recommended product information being related to the current product information content through the parameter value; and
including at least some of the recommended product information into the content of the landing page.

10. The method as claimed in claim 1, the method further comprising:
searching in the product information database for recommended product information of a recommended product, the recommended product information being related to the current product information content through the parameter value; and
including at least some of the recommended product information into the content of the landing page.

11. The method as claimed in claim 10, wherein the recommended product information is defined according to a preset similarity rule in relation to the parameter value.

12. The method as claimed in claim 1, wherein automatically organizing the content of the landing page using the product information detail of the product information comprises:
including recommended product information into the content of the landing page, along with the product information detail associated with the current product information content, wherein the recommended product information is related to the current product information content according to a preset similarity rule in relation to the parameter value.

13. The method as claimed in claim 1, wherein automatically organizing the content of the landing page comprises:
extracting from a link address of the current product information content an HTML text;
adding the product information detail associated with the current product information content to a first location of the HTML text;
adding recommended product information to a second location of the HTML text, wherein the recommended product information is related to the current product information content according to a preset similarity rule in relation to the parameter value; and
including the resultant HTML text in the landing page.

14. The method as claimed in claim 13, wherein the first location containing the product information detail associated with the current product information content is rendered at a top of the landing page.

15. The method as claimed in claim 13, wherein the recommended product information is retrieved from the product information database by performing a search based on the similarity rule in relation to the parameter value.

16. The method as claimed in claim 1, wherein, prior to determining the parameter value of the current product information content by parsing the access request, the method further comprising:
determining whether the access page is another landing page of a previous access request; and
updating a statistics of the current product information content if the determination is affirmative, and skipping the statistics if the determination is negative.

17. The method as claimed in claim 1, wherein the parameter value includes a statistics link of the current product information content, and automatically organizing the content of the landing page comprises:
including the statistics link into the content of the landing page along with the product information detail associated with the current product information content.

18. The method as claimed in claim 1, the method further comprises a process of generating a statistics link of the product information content and including the statistics link in the parameter value, the process comprising:
obtaining historical click rates of various product information contents on the access page;
retrieving click prices of the various product information contents;
ranking the various product information contents according to the respective historical click rates and click prices;
determining if the next product information content in the ranking has a click price greater than the click price of the current product information content; and
generating the statistics link using the click price of the current product information content if the determination is affirmative, or generating the statistics link using the click price of the next product information content in the ranking if the determination is negative.

19. A method for generating page content, the method comprising:
at a product information server system,
storing in a product information database a plurality of parameter values of various product information contents and corresponding product information details of the various product information contents,
placing a current product information content on a webpage,
receiving from a web server a parameter value of the current product information content visited on the webpage,
searching the product information database to find a product information detail corresponding to the current product information content, and
returning the found product information detail to the web server; and
at the web server, automatically organizing a content of a landing page using the received product information detail.

20. A computer-based apparatus for generating page content, the apparatus comprising:
a computer having a processor, computer-readable memory and storage medium, and I/O devices, the computer being programmed to have functional modules including:
a database module configured for storing in a product information database a plurality of parameter values of various product information contents and corresponding product information details of the various product information contents, and for placing a current product information content on a webpage;
a parameter value determination module configured for receiving from a web server a parameter value of the current product information content visited on the webpage; and
a search module configured for finding a product information detail corresponding to the current product information content and returning the found product information detail to the web server, to allow the web server to automatically organize a content of a landing page using the received product information detail.
